(19) United States
(12) Patent Application Publication
(10) Pub. No.: US 2025/0329832 A1
(43) Pub. Date: Oct. 23, 2025

(54) BATTERY CASE, BATTERY INCLUDING SAME, AND METHOD OF MANUFACTURING BATTERY CASE

(71) Applicant: Samsung SDI Co., Ltd., Yongin-si (KR)

(72) Inventors: Soo-Mi Eo, Yongin-si (KR); Jeawoan Lee, Yongin-si (KR)

(73) Assignee: Samsung SDI Co., Ltd., Yongin-si (KR)

(21) Appl. No.: 18/913,419

(22) Filed: Oct. 11, 2024

(30) Foreign Application Priority Data
Apr. 19, 2024 (KR) 10-2024-0052682

(51) Int. Cl. H01M 50/124; H01M 50/105; H01M 50/119; H01M 50/121; H01M 50/133

(52) U.S. Cl. CPC H01M 50/124; H01M 50/105; H01M 50/119; H01M 50/121; H01M 50/133

(57) ABSTRACT

Provided is a battery case including a lower case including a metal layer, an adhesive layer, and a polymer layer. To this end, the battery case includes: a lower case including an accommodation portion for accommodating an electrode assembly and a flange portion surrounding the accommodation portion, and an upper cover arranged to at least partially face the flange portion of the lower case. At least a portion of the lower case has a laminated structure in which a metal layer exposed to the outside, an adhesive layer in contact with the metal layer, and a polymer layer in contact with the adhesive layer are laminated.

### CROSS-REFERENCE TO RELATED APPLICATIONS

This present application claims priority to and the benefit under 35 U.S.C. § 119(a)-(d) of Korean Patent Application No. 10-2024-0052682, filed on Apr. 19, 2024, in the Korean Intellectual Property Office, the entire disclosure of which is incorporated herein by reference.

### FIELD

Aspects of embodiments of the present disclosure relate to a battery case, a battery including the same, and a method of manufacturing the battery case. Particularly, aspects of embodiments of the present disclosure relate to a battery case having a laminated structure in which a metal layer, an adhesive layer, and a polymer layer are laminated, a battery including the same, and a method of manufacturing the battery case.

### BACKGROUND

Unlike primary batteries that are not designed to be (re) charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

Due to the change in component placement design and requirements for weight reduction following the launch of new models, pouch-type batteries that have excellent ductility and are relatively lightweight are often used as batteries for small electronic devices such as smartphones. Pouch-type batteries that use composite materials with excellent ductility have a problem in that wrinkles or deformation occurs on the exterior of the pouch when the batteries are replaced after being installed in a battery placement space. Due to this, a square case using stainless steel, which is stronger than existing aluminum materials, has been proposed as a battery for small electronic devices. However, in order to mold a square case formed of stainless steel without defects, the thickness of the stainless steel material is required to be 100 μm or more, which causes the problem of increasing the weight of the battery.

The above information disclosed in this Background section is for enhancement of understanding of the background of the present disclosure, and therefore, it may contain information that does not constitute related (or prior) art.

### SUMMARY

Aspects of embodiments of the present disclosure provide a battery case, a battery including the same, and a method of manufacturing the battery case.

These and other aspects and features of the present disclosure will be described in or will be apparent from the following description of embodiments of the present disclosure.

According to embodiments, a battery case includes: a lower case including an accommodation portion for accommodating an electrode assembly and a flange portion surrounding the accommodation portion; and an upper cover arranged to at least partially face the flange portion of the lower case, wherein at least a portion of the lower case has a laminated structure in which a metal layer exposed to an outside, an adhesive layer in contact with the metal layer, and a polymer layer in contact with the adhesive layer are laminated.

According to embodiments, the metal layer may be formed of a stainless steel.

According to embodiments, the metal layer may have a thickness falling within a range of 30 μm to 60 μm.

According to embodiments, the polymer layer may be formed of casted polypropylene.

According to embodiments, the polymer layer may have a thickness falling within a range of 20 μm to 30 μm.

According to embodiments, at least a portion of the upper cover may have the same laminated structure as the lower case, and the laminated structure may be formed by bonding the polymer layer to the adhesive layer applied onto one surface of the metal layer by a laminating method.

According to embodiments, the accommodation portion of the lower case may include a bottom surface arranged spaced apart from the flange portion and a sidewall portion connecting the flange portion to thee bottom surface, and the sidewall portion may include a first side surface adjacent to one long side of the bottom surface, a second side surface facing the first side surface, a third side surface adjacent to one short side of the bottom surface, and a fourth side surface facing the third side surface.

According to embodiments, each of a corner portion, where the bottom surface and the first side surface are connected, and a corner portion, where the bottom surface and the second side surface are connected, may have a first curvature radius, each of a corner portion, where the bottom surface and the third side surface are connected, and a corner portion, where the bottom surface and the fourth side surface are connected, may have a second curvature radius, and each of a corner portion, where the first side surface and the third side surface are connected, a corner portion, where the first side surface and the fourth side surface are connected, a corner portion, where the second side surface and the third side surface are connected, and a corner portion, where the second side surface and the fourth side surface are connected, may have a third curvature radius.

According to embodiments, the first curvature radius may be equal to the second curvature radius.

According to embodiments, the third curvature radius may be greater than the first curvature radius and the second curvature radius.

According to embodiments, the first curvature radius and the second curvature radius may be greater than 0 mm and less than 1 mm.

According to embodiments, the first curvature radius and the second curvature radius may be greater than 0 mm and less than 0.5 mm.

According to embodiments, at least a portion of the upper cover and the flange portion of the lower case may be joined by heat fusion of a polymer layer between the laminated structures.

According to embodiments, the lower case may be manufactured by: performing first molding by pressing a composite substrate including the metal layer, the adhesive layer, and the polymer layer to a first depth using a first mold including a punch having a first corner curvature radius; performing second molding by pressing the first-molded composite substrate to a second depth using a second mold including a punch having a second corner curvature radius; and performing third molding by pressing the second-molded composite substrate to a third depth using a third mold including a punch having a third corner curvature radius, the first corner curvature radius, the second corner curvature radius, and the third corner curvature radius may be different from one another, and the first depth, the second depth, and the third depth may be different from one another.

According to embodiments, the first corner curvature radius may be greater than the second corner curvature radius, and the second corner curvature radius may be greater than the third corner curvature radius.

According to embodiments, the first depth may be less than the second depth, and the second depth may be less than the third depth.

According to embodiments, a battery includes: an electrode assembly including a positive electrode, a negative electrode, and a separator; and the battery case according to embodiments of the present disclosure.

According to embodiments, a method of manufacturing a battery case includes: preparing a composite substrate including a metal layer, an adhesive layer, and a polymer layer; and manufacturing a lower case by molding the composite substrate using punches having different corner curvature radii, wherein the composite substrate has a laminated structure in which the metal layer exposed to an outside, the adhesive layer in contact with the metal layer, and the polymer layer in contact with the adhesive layer are laminated.

According to embodiments, the manufacturing of the lower case may include: performing first molding by pressing the composite substrate to a first depth using a first mold including a punch having a first corner curvature radius; performing second molding by pressing the first-molded composite substrate to a second depth using a second mold including a punch having a second corner curvature radius; and performing third molding by pressing the second-molded composite substrate to a third depth using a third mold including a punch having a third corner curvature radius, the first corner curvature radius, the second corner curvature radius, and the third corner curvature radius may be different from one another, and the first depth, the second depth, and the third depth may be different from one another.

According to some embodiments of the present disclosure, when manufacturing the pouch-type battery case using the stainless steel composite substrate, the accommodation space for the electrode assembly may be additionally secured by forming stainless steel to a thickness within a range of 30 μm to 60 μm. Due to this, the battery capacity may be increased.

According to some embodiments of the present disclosure, the electrode assembly accommodation portion with a certain depth may be formed without defects while reducing the corner curvature radii of the accommodation portion through the multi-stage molding, and thus, the battery capacity accommodated in the battery case may be increased.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 illustrates an exploded perspective view showing a structure of a battery according to embodiments of the present disclosure;

FIG. 2 illustrates a diagram showing an example of a composite substrate according to embodiments of the present disclosure;

FIG. 3 illustrates an exploded perspective view of a battery case according to embodiments of the present disclosure;

FIG. 4 illustrates a cross-sectional view of a battery according to embodiments of the present disclosure;

FIG. 5 illustrates a cross-sectional view of a battery according to embodiments of the present disclosure;

FIG. 6 illustrates a perspective view of a lower case, when viewed from the bottom, according to embodiments of the present disclosure;

FIG. 7 illustrates an example of a process of manufacturing a lower case by using a composite substrate according to embodiments of the present disclosure; and

FIG. 8 illustrates a flowchart for describing a method of manufacturing a battery case according to embodiments of the present disclosure.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112 (a) and 35 U.S.C. § 132 (a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components “.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

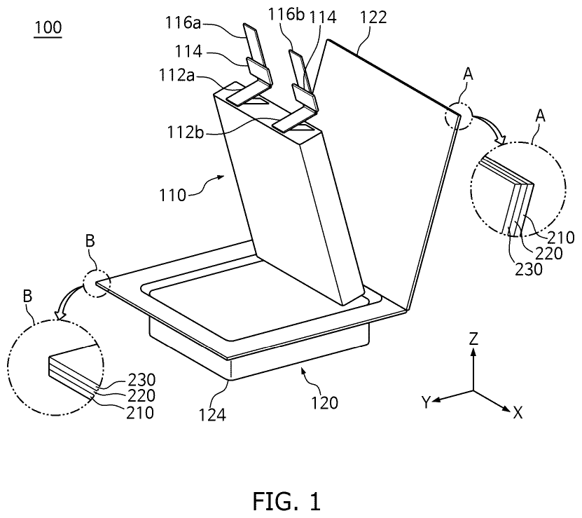

FIG. 1 is an exploded perspective view showing a structure of a battery 100 according to embodiments of the present disclosure. For example, the battery 100 may be a pouch-type secondary battery. As illustrated in FIG. 1, the battery 100 may include a battery case 120 and an electrode assembly 110 arranged inside the battery case 120.

The electrode assembly 110 includes a negative electrode plate as a first electrode plate, a positive electrode plate as a second electrode plate, and a separator interposed therebetween. The negative plate and the positive plate may be wound with a separator, which is an insulator, located therebetween. However, the scope of the present disclosure is not limited thereto, and the electrode assembly 110 may have a laminated structure in which the negative electrode plate and the positive electrode plate each including a plurality of sheets are alternately laminated with the separator therebetween. The negative electrode plate may include a negative electrode tab 112a electrically connected to a negative electrode uncoated portion, and the positive electrode plate may include a positive electrode tab 112b electrically connected to a positive electrode uncoated portion. The negative electrode tab 112a and the positive electrode tab 112b are respectively welded to a negative electrode lead 116a and a positive electrode lead 116b of an external terminal to be electrically connected to the outside. A tab film 114 for insulation from the battery case 120 is attached to the negative electrode lead 116a and the positive electrode lead 116b.

The battery case 120 may include an upper cover 122 and a lower case 124. The upper cover 122 may be in the form of a plate. The lower case 124 may include an accommodation portion for accommodating the electrode assembly 110 and a flange portion surrounding the accommodation portion.

The upper cover 122 and the lower case 124 may be sealed by the flange portion of the lower case 124 and a partial area of the upper cover 122 coming into contact with each other while the electrode assembly 110 is accommodated in the accommodation portion of the lower case 124.

The battery 100 may be a lithium battery cell or the like. However, the scope of the present disclosure is not limited thereto, and the battery 100 includes any battery that is capable of repeatedly providing electricity through charging and discharging.

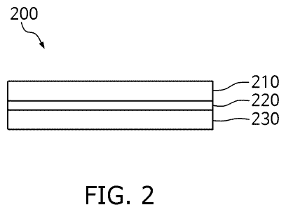

According to embodiments, at least a portion of the upper cover 122 and/or the lower case 124 of the battery case 120 may have a laminated structure in which a metal layer 210 exposed to the outside, an adhesive layer 220 in contact with the metal layer 210, and a polymer layer 230 in contact with the adhesive layer 220 are laminated. This arrangement is described in detail later with reference to FIG. 2.

FIG. 2 is a diagram showing an example of a composite substrate 200 according to embodiments of the present disclosure. As illustrated in FIG. 2, the composite substrate 200 may have a laminated structure in which the metal layer 210 exposed to the outside, the adhesive layer 220 in contact with the metal layer 210, and the polymer layer 230 in contact with the adhesive layer 220 are laminated. The adhesive layer 220 may be arranged between the metal layer 210 and the polymer layer 230 and come into contact with the metal layer 210 and the polymer layer 230. For example, the composite substrate 200 may be formed by bonding the polymer layer 230 to the adhesive layer 220 applied on one surface of the metal layer 210 by using a laminating method.

According to embodiments, the metal layer 210 may be formed of stainless steel. In this circumstance, the thickness of the metal layer 210 may fall within a range of 30 μm to 60 μm.

According to embodiments, the polymer layer 230 may be formed of casted polypropylene (CPP). In this circumstance, the thickness of the polymer layer 230 may fall within a range of 20 μm to 30 μm. The thickness of the polymer layer 230 may be approximately 25 μm.

Table 1 below shows experimental data for an aluminum (Al) composite substrate and a stainless steel (STS) composite substrate. In the present experimental data, the Al composite substrate is a composite substrate in which an aluminum layer, a nylon layer, and a CPP layer are bonded. In addition, a first STS composite substrate is a composite substrate in which a stainless steel layer, a nylon layer, and a CPP layer are bonded, and a second STS composite substrate is a composite substrate in which a stainless steel layer and a CPP layer are bonded.

TABLE 1

| | Classification | | | | | | | | | | | | |
|---|---|---|---|---|---|---|---|---|---|---|---|---|---|
| | Aluminum | | | First STS | | | | | | | | | |
| | Composite | | | composite | | | | | | | | | |
| | substrate | | | substrate | | | Second STS composite substrate | | | | | | |
| | Material | | | | | | | | | | | | |
| | Al | | | STS | | | STS | | | | | | |
| | Molding method | | | | | | | | | | | | |
| | One-time molding | | | | | | Multi-stage molding | | | | | | |
| Thickness of metal | 35 | | | 20 | | | 20 | | | 30 | | | 40 |
| layer (μm) | | | | | | | | | | | | | |
| Thickness of nylon | 18 | | | 18 | | | — | | | — | | | — |
| layer (μm) | | | | | | | | | | | | | |
| Thickness of CPP | 33 | | | 25 | | | 25 | | | 25 | | | 25 |
| layer (μm) | | | | | | | | | | | | | |
| Thickness of | 86 | | | 63 | | | 45 | | | 55 | | | 65 |
| substrate (μm) | | | | | | | | | | | | | |
| Depth of | 4 | 4.5 | 6 | 4 | 5 | 6 | 4 | 5 | 6 | 4 | 5 | 6 | 4 |
| accommodation | | | | | | | | | | | | | |
| portion (mm) | | | | | | | | | | | | | |
| Corner wrinkles | — | —* | ◯ | ◯ | ◯ | ◯ | — | ◯* | ◯ | — | — | — | — |

| Battery capacity | 100% | 102.1% | 101.6% | 101.1% |
|---|---|---|---|---|
| | (4 mm) | | | |

| | Classification | | | | | | | | | | |
|---|---|---|---|---|---|---|---|---|---|---|---|
| | Second STS composite substrate | | | | | | | | | | |
| | Material | | | | | | | | | | |
| | STS | | | | | | | | | | |
| | Molding method | | | | | | | | | | |
| | Multi-stage molding | | | | | | | | | | |
| Thickness of metal | 40 | | 50 | | | 60 | | | 100 | | |
| layer (μm) | | | | | | | | | | | |
| Thickness of nylon | — | | — | | | — | | | — | | |
| layer (μm) | | | | | | | | | | | |
| Thickness of CPP | 25 | | 25 | | | 25 | | | — | | |
| layer (μm) | | | | | | | | | | | |
| Thickness of | 65 | | 75 | | | 85 | | | Square | | |
| substrate (μm) | | | | | | | | | shape | | |
| Depth of | 5 | 6 | 4 | 5 | 6 | 4 | 5 | 6 | 4 | 5 | 6 |
| accommodation | | | | | | | | | | | |
| portion (mm) | | | | | | | | | | | |
| Corner wrinkles | — | — | — | — | — | — | — | — | — | — | — |

| | | | | |
|---|---|---|---|---|
| Battery capacity | 101.1% | 100.6% | 100.1% | 100.2% |

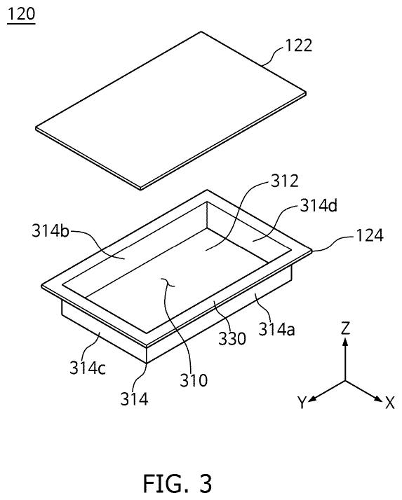

Table 1 includes data regarding whether wrinkles (or cracks) occur at the corners of the accommodation portion according to the depth of the accommodation portion when the accommodation portion (e.g., 310 of FIG. 3) of the lower case is formed by molding the Al composite substrate and the STS composite substrate (the first and second STS composite substrates).

When the accommodation portion of the lower case was formed by molding the Al composite material once, it was confirmed that no wrinkles occurred at the corners of the accommodation portion when the depth of the accommodation portion was within a range of 4 mm or 4.5 mm. However, it was confirmed that the thickness of the Al layer was reduced to less than 20 μm at the point where the depth of the accommodation portion was 4.5 mm, depending on the characteristics of aluminum having a high elongation rate (indicated by “—*” in the table). Accordingly, it was confirmed that it could not prevent the invasion of moisture when the depth of the accommodation portion was 4.5 mm or more. In addition, it was confirmed that wrinkles occurred at the corners of the accommodation portion when the accommodation portion was formed to have a depth of 6 mm.

When the accommodation portion of the lower case was formed by one-time molding using the first STS composite substrate, it was confirmed that wrinkles occurred at the corners of the accommodation portion when the depth of the accommodation portion was 4 mm, 5 mm, or 6 mm.

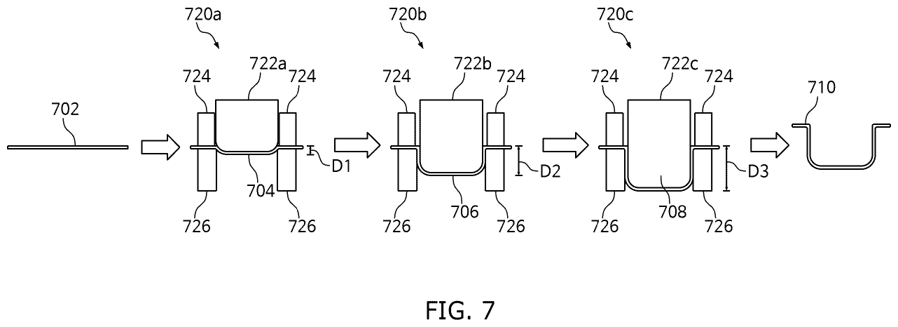

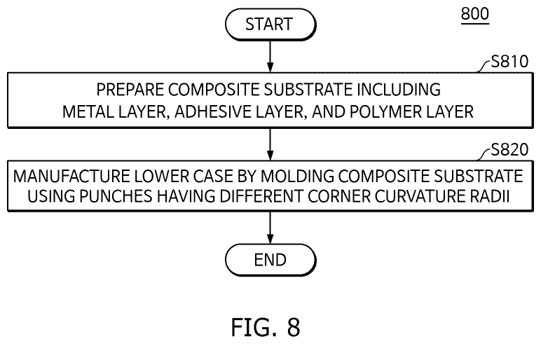

Table 1 includes data regarding whether wrinkles occur at the corners of the accommodation portion according to the depth of the accommodation portion when the accommodation portion of the lower case is formed by multi-stage molding of the second STS composite substrate. The multi-stage molding is a method of forming the lower case while gradually increasing the pressing depth by using punches having different corner curvature radii. This is described in detail with reference to FIGS. 7 and 8.

In the multi-stage molding of the second STS composite substrate, it was confirmed that no wrinkles occurred at the corners of the accommodation portion when the thickness of the STS layer was 20 μm and the depth of the accommodation portion was 4 mm. However, it was confirmed that when the depth of the accommodation portion was 5 mm, weak wrinkles occurred at the corners of the accommodation portion (indicated “O*” in the table), and when the depth of the accommodation portion was 6 mm, wrinkles occurred at the corners of the accommodation portion.

In the multi-stage molding of the second STS composite substrate, it was confirmed that no wrinkles occurred at the corners of the accommodation portion when the thickness of the STS layer was 30 μm to 60 μm and the depth of the accommodation portion was 4 mm to 6 mm.

In the multi-stage molding of the second STS composite substrate, data regarding the rate of increase in battery capacity when the depth of the accommodation portion was 5 mm and the thickness of the STS layer was 30 μm to 60 μm. The battery capacity is based on the battery capacity using the lower case when the accommodation portion is formed to have a depth of 4 mm during one-time molding of the Al composite substrate. Referring to Table 1, it was confirmed that the battery capacity was the highest at 101.6% when the thickness of the STS layer was 30 μm.

As a comparative example, Table 1 includes data regarding whether wrinkles occur at the corners of the accommodation portion for the pouch-type battery case using the second STS composite material with an STS layer thickness of 100 μm. In this case, it was confirmed that no wrinkles occurred at the corners of the accommodation portion when the depth of the accommodation portion was 4 mm, 5 mm, or 6 mm.

Table 2 below shows experimental data for an Al composite substrate, and Table 3 below shows experimental data for an STS composite substrate to which an STS layer and a CPP layer are bonded.

TABLE 2

| | |
|---|---|
| Classification | Al material (Pouch-type) |

| | | |
|---|---|---|
| Thickness of nylon layer (μm) | 28 | 18 |
| Thickness of Al layer (μm) | 40 | 35 |
| Thickness of CPP layer (μm) | 43 | 33 |
| Thickness of substrate (μm) | 110 | 86 |
| Tensile strength (Mpa) | 140.0 | 94.7 |

TABLE 3

| | | | | | | | STS |
|---|---|---|---|---|---|---|---|
| | | | | | | | material |
| | STS material | | | | | | (Square |
| Classification | (Pouch-type) | | | | | | shape) |
| Thickness of | 20 | 30 | 40 | 50 | 60 | 70 | 100 |
| STS layer | | | | | | | |
| (μm) | | | | | | | |
| Thickness of | 25 | 25 | 25 | 25 | 25 | 25 | |
| CPP layer | | | | | | | |
| (μm) | | | | | | | |
| Thickness of | 45 | 55 | 65 | 75 | 85 | 95 | 100 |
| substrate | | | | | | | |
| (μm) | | | | | | | |
| Tensile | 238.1 | 273.3 | 308.5 | 343.7 | 378.9 | 414.1 | 519.7 |
| strength | | | | | | | |
| (Mpa) | | | | | | | |

Referring to Table 2 and Table 3, when the thickness of the STS layer is 30 μm, the tensile strength is found to be 238.1 Mpa. It was confirmed that the tensile strength was 52.5% of the tensile strength of the STS composite substrate used in the square battery case (when the thickness of the STS layer is 100 μm) and was 195.2% of the tensile strength of the Al composite substrate (when the thickness of the Al layer is 40 μm). When the thickness of the STS layer is 60 μm, the tensile strength thereof is found to be 378.9 Mpa. It was confirmed that the tensile strength was 72.9% of the tensile strength of the STS composite substrate used in the pouch-type battery case (when the thickness of the STS layer is 100 μm) and was 270.6% of the tensile strength of the Al composite substrate (when the thickness of the Al layer is 40 μm).

Accordingly, it can be confirmed that, in manufacturing the pouch-type battery case using the STS composite material, when the thickness of the STS is within a range of 30 μm to 60 μm, no wrinkles occur at the corners of the lower case and the accommodation space of the electrode assembly can be additionally secured. Due to this, the battery capacity may be increased. In addition, it can be seen that when the thickness of the STS is within the range of 30 μm to 60 μm, the tensile strength is greatly increased compared to the case of using the Al composite substrate.

FIG. 3 is an exploded perspective view of the battery case 120 according to embodiments of the present disclosure. The battery case 120 may include an upper cover 122 and a lower case 124. The upper cover 122 may be in the form of a plate. The upper cover 122 may be arranged on the upper portion of the lower case 124 and may cover the open upper portion of the lower case.

The lower case 124 may include an accommodation portion 310 for accommodating the electrode assembly 110 and a flange portion 320 surrounding the accommodation portion 310. In some embodiments, the accommodation portion 310 may be formed to have a depth of 3 mm or more and less than 6 mm. The accommodation portion 310 of the lower case 124 may include a bottom surface 312 spaced apart from the flange portion 320 and a sidewall portion connecting the flange portion 330 to the bottom surface 312. The sidewall portion may include a first side surface 314a adjacent to one long side of the bottom surface 312, a second side surface 314b facing the first side 314a, a third side surface 314c adjacent to one short side of the bottom surface 311, and a fourth side surface 314d facing the third side surface 314c.

The flange portion 330 of the lower case 124 may be an area that is sealed in contact with the upper cover 122. For example, at least a portion of the upper cover 122 and the flange portion 330 of the lower case 124 may be joined by heat fusion of a polymer layer between the laminated structures. However, the scope of the present disclosure is not limited thereto, and the joining method of the battery case 120 may use various methods that may perform sealing by joining the upper cover 122 to the lower case 124.

FIG. 3 illustrates the upper cover 122 in the form of a plate, but the shape of the upper cover 122 is not limited thereto, and the shape of the upper cover 122 may be identical to or similar to the shape of the lower case 124. In this case, the flange portions respectively formed on the upper cover 122 and the lower case 124 may be joined while facing one another, and the electrode assembly may be accommodated in the accommodation space formed by joining the upper cover 122 to the lower case 124.

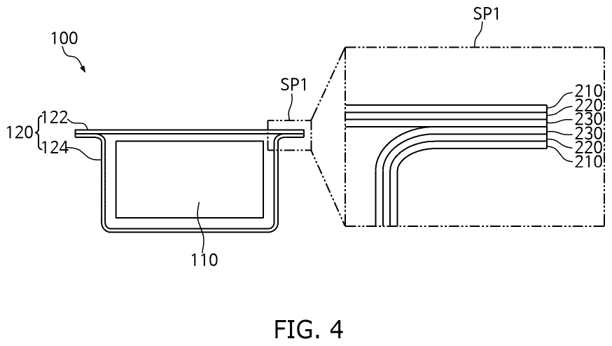

FIG. 4 is a cross-sectional view of the battery 100 according to embodiments of the present disclosure. FIG. 4 is a cross-sectional view of a battery 100 in a Y direction. As illustrated in FIG. 4, in a state in which an electrode assembly 110 is accommodated in a lower case 124, a flange portion of the lower case 124 may be sealed in contact with a partial area of an upper cover 122. A partial area of the upper cover 122 may correspond to an area facing the flange portion of the lower case 124.

Referring to a sealing area SP1 of FIG. 4, each of the upper cover 122 and the lower case 124 may include a metal layer 210, an adhesive layer 220, and a polymer layer 230. The polymer layers 230 of the upper cover 122 and the lower case 124 may be bonded to each other. For example, at least a portion of the upper cover 122 and the flange portion 330 of the lower case 124 may be joined by heat fusion of a polymer layer between the laminated structures. However, the scope of the present disclosure is not limited thereto.

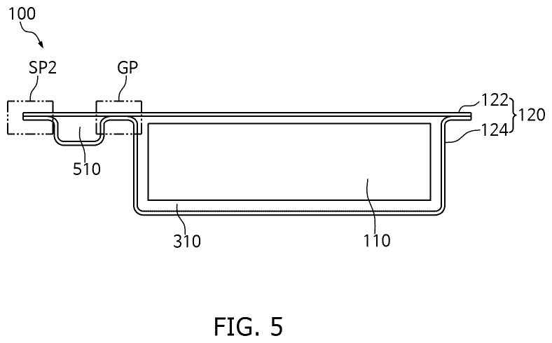

FIG. 5 is a cross-sectional view of a battery 100 according to embodiments of the present disclosure. FIG. 5 is a cross-sectional view of the battery 100 in an X direction. In the battery 100, a gas pocket 510 may be formed at a location where a positive electrode lead is arranged. The gas pocket 510 may be formed to collect gas generated during a charging/discharging test process for the activation of electrode active materials. The gas pocket 510 may be located spaced apart from the accommodation portion 310 of the lower case 124 in a direction (e.g., the Y direction) in which the positive electrode lead is arranged. The gas pocket 510 may be formed by being recessed to a certain depth from the upper end of the lower case 124 in a downward direction (e.g., a −Z direction). The gas generated during the charging/discharging test process may be collected in the gas pocket 510 through a gas passage GP.

In this circumstance, a sealing area SP2 between the upper cover 122 and the lower case 124 may be formed in an area where the upper cover 122 faces the flange extending along one sidewall of the gas pocket 510. Each of the upper cover 122 and lower case 124 may include a metal layer 210, an adhesive layer 220, and a polymer layer 230. As described with reference to FIG. 4, the polymer layers of the upper cover 122 and the lower case 124 may be bonded to each other.

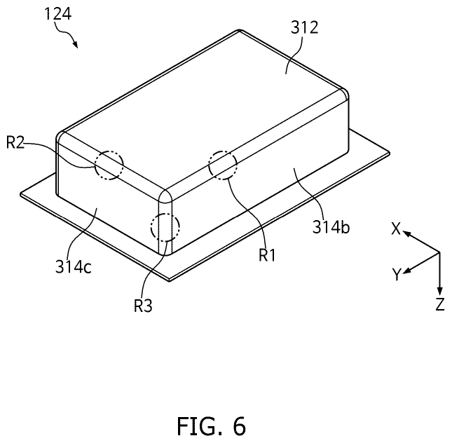

FIG. 6 is a perspective view of the lower case 124, when viewed from the bottom, according to embodiments of the present disclosure. According to some embodiments, corner portions of the lower case 124 connected to the bottom surface and each side surface constituting the sidewall portion may be curved. For example, the corner portion where a bottom surface 312 and a second side surface 314b are connected may have a first curvature radius R1. In this circumstance, although not illustrated in FIG. 6, the corner portion where the bottom surface 312 and a first side surface opposite to the second side surface 314b are connected may also have the first curvature radius R1.

The corner portion where the bottom surface 312 and a third side surface 314c are connected may have a second curvature radius R2. In this circumstance, although not illustrated in FIG. 6, the corner portion where the bottom surface 312 and a fourth side surface opposite to the third side surface 314c are connected may also have the second curvature radius R2.

The corner portion where the second side surface 314b and the third side surface 314c are connected may have a third curvature radius R3. In this circumstance, although not illustrated in FIG. 6, a corner portion where the first side surface and the third side surface are connected, a corner portion where the first side surface and the fourth side surface are connected, and a corner portion where the second side surface and the fourth side surface are connected may also have the third curvature radius R3.

In some embodiments, the first curvature radius R1 and the second curvature radius R2 may be equal to each other. Additionally, the third curvature radius R3 may be greater than the first curvature radius R1 and the second curvature radius R2. For example, the first curvature radius R1 and the second curvature radius R2 may be greater than 0 mm and less than 1 mm. As another example, the first curvature radius R1 and the second curvature radius R2 may be greater than 0 mm and 0.5 mm or less. When the first curvature radius R1 and the second curvature radius R2 are approximately 0.5 mm, moldability may be excellent.

The curved corner portions of the lower case 124 may be formed through multi-stage molding. A specific method of manufacturing the lower case 124 through multi-stage molding using a composite substrate (e.g., 200 of FIG. 2) is described with reference to FIGS. 7 and 8.

FIG. 7 illustrates an example of a process of manufacturing a lower case 710 by using a composite substrate 702 according to embodiments of the present disclosure. The composite substrate 702 illustrated in FIG. 7 may correspond to the composite substrate 200 of FIG. 2, and the lower case 710 may correspond to the lower case 124 of FIG. 1.

According to some embodiments, the curved corner portions of the lower case 710 may be formed through multi-stage molding. For example, the lower case 710 may be manufactured by molding the composite substrate 702 using a plurality of molds 720a, 720b, and 720c. The plate-type composite substrate 702 may be sequentially inserted into the first mold 720a, the second mold 720b, and the third mold 720C and may be then multi-stage molded. As a result, the lower case 710 with the curved corner portions may be manufactured.

The molds 720a, 720b, and 720c may respectively include punches 722a, 722b, and 722c having different corner curvature radii, strippers 724 that descend together with the punches 722a, 722b, and 722c to fix the composite substrate, and dies 726 that fix the composite substrate together with the stripper.

The first punch 722a of the first mold 720a may have a first corner curvature radius, the second punch 722b of the second mold 720 may have a second corner curvature radius, and the third mold 722c of the third mold 720c may have a third corner curvature radius. In this circumstance, the first corner curvature radius, the second corner curvature radius, and the third corner curvature radius may be different from each other.

Referring to FIG. 7, the composite substrate 702 may be inserted into the first mold 720a. The first mold 720a may perform first molding by pressing the composite substrate 702 to a first depth D1. Subsequently, the first-molded composite substrate 704 may be inserted into the second mold 720b. The second mold 720b may perform second molding by pressing the first-molded composite substrate 704 to a second depth D2. Subsequently, the second-molded composite substrate 706 may be inserted into the third mold 720c. The third mold 720c may perform third molding by pressing the second-molded composite substrate 706 to a third depth D3. The third-molded composite substrate 708 is a lower case 710 in which an electrode assembly is accommodated and may be joined to an upper cover (e.g., 122 of FIG. 3) to constitute a battery case.

In some embodiments, the first depth D1, the second depth D2, and the third depth D3 may be different from each other. For example, the first depth D1 may be less than the second depth D2, and the second depth D2 may be less than the third depth D3.

In addition, FIG. 7 illustrates that the three molds 720a, 720b, and 720c manufacture the lower case 710, but the present disclosure is not limited thereto, and a different number of molds may be configured to manufacture the lower case 710. In this circumstance, the molds may have different corner curvature radii, and the pressed depths of the molds may also be different from each other.

When forming an electrode assembly accommodation portion with a certain depth through one-time molding using a mold device, there is a problem in that excessive tensile force is applied to the corners of the accommodation portion, thus causing wrinkles therein. In contrast, the electrode assembly accommodation portion with a certain depth may be formed without defects while reducing the corner curvature radii of the accommodation portion through the multi-stage molding described with reference to FIG. 7, and thus, the battery capacity accommodated in the battery case may be increased.

FIG. 8 is a flowchart for describing a method 800 of manufacturing a battery case according to embodiments of the present disclosure. The method 800 may be performed by a battery case manufacturing device, etc. (hereinafter referred to as a manufacturing apparatus). The manufacturing apparatus (for example, a composite substrate manufacturing part of the manufacturing apparatus) may prepare a composite substrate including a metal layer, an adhesive layer, and a polymer layer (S810). For example, the manufacturing apparatus may manufacture the composite substrate by applying the adhesive layer onto one side of the metal layer and bonding the polymer layer to the applied adhesive layer by using a laminating method.

The manufacturing apparatus (e.g., a molding part of the manufacturing apparatus) may manufacture the lower case by molding the composite substrate using punches having different corner curvature radii (S820).

Specifically, the manufacturing apparatus may perform first molding by pressing the composite substrate including the metal layer, the adhesive layer, and the polymer layer to a first depth using a first mold including a punch having a first corner curvature radius. Subsequently, the manufacturing apparatus may perform second molding by pressing the first-molded composite substrate to a second depth using a second mold including a punch having a second corner curvature radius. Subsequently, the manufacturing apparatus may perform third molding by pressing the second-molded composite substrate to a third depth using a third mold including a punch having a third corner curvature radius. The first corner curvature radius, the second corner curvature radius, and the third corner curvature radius may be different from each other. For example, the first corner curvature radius may be greater than the second corner curvature radius, and the second corner curvature radius may be greater than the third corner curvature radius. In addition, the first depth, the second depth, and the third depth may be different from each other. For example, the first depth may be less than the second depth, and the second depth may be less than the third depth.

Although the present disclosure has been described above with respect to embodiments thereof, the present disclosure is not limited thereto. Various modifications and variations can be made thereto by those skilled in the art within the spirit of the present disclosure and the equivalent scope of the appended claims.

### DESCRIPTION OF SOME REFERENCE SYMBOLS

100: battery
110: electrode assembly
120: battery case

What is claimed is:

1. A battery case comprising:
a lower case configured to comprise an accommodation portion for accommodating an electrode assembly and a flange portion surrounding the accommodation portion; and
an upper cover arranged to at least partially face the flange portion of the lower case,
wherein at least a portion of the lower case has a laminated structure in which a metal layer exposed to an outside, an adhesive layer in contact with the metal layer, and a polymer layer in contact with the adhesive layer are laminated.

2. The battery case as claimed in claim 1, wherein the metal layer is a stainless steel layer.

3. The battery case as claimed in claim 2, wherein the metal layer has a thickness within a range of 30 μm to 60 μm.

4. The battery case as claimed in claim 3, wherein the polymer layer is formed of casted polypropylene.

5. The battery case as claimed in claim 4, wherein the polymer layer has a thickness within a range of 20 μm to 30 μm.

6. The battery case as claimed in claim 1, wherein at least a portion of the upper cover has the same laminated structure as the lower case, and
the laminated structure is formed by bonding the polymer layer to the adhesive layer applied onto one surface of the metal layer by a laminating method.

7. The battery case as claimed in claim 1, wherein the accommodation portion of the lower case comprises a bottom surface arranged spaced apart from the flange portion and a sidewall portion connecting the flange portion to the bottom surface, and
the sidewall portion comprises a first side surface adjacent to one long side of the bottom surface, a second side surface facing the first side surface, a third side surface adjacent to one short side of the bottom surface, and a fourth side surface facing the third side surface.

8. The battery case as claimed in claim 7, wherein each of a corner portion, where the bottom surface and the first side surface are connected, and a corner portion, where the bottom surface and the second side surface are connected, has a first curvature radius,
each of a corner portion, where the bottom surface and the third side surface are connected, and a corner portion, where the bottom surface and the fourth side surface are connected, has a second curvature radius, and
each of a corner portion, where the first side surface and the third side surface are connected, a corner portion, where the first side surface and the fourth side surface are connected, a corner portion, where the second side surface and the third side surface are connected, and a corner portion, where the second side surface and the fourth side surface are connected, has a third curvature radius.

9. The battery case as claimed in claim 8, wherein the first curvature radius is equal to the second curvature radius.

10. The battery case as claimed in claim 9, wherein the third curvature radius is greater than the first curvature radius and the second curvature radius.

11. The battery case as claimed in claim 10, wherein the first curvature radius and the second curvature radius are greater than 0 mm and less than 1 mm.

12. The battery case as claimed in claim 11, wherein the first curvature radius and the second curvature radius are greater than 0 mm and less than 0.5 mm.

13. The battery case as claimed in claim 6, wherein at least a portion of the upper cover and the flange portion of the lower case are joined by heat fusion of a polymer layer between the laminated structures.

14. The battery case as claimed in claim 1, wherein the lower case is manufactured by:
performing first molding by pressing a composite substrate including the metal layer, the adhesive layer, and the polymer layer to a first depth using a first mold including a punch having a first corner curvature radius;
performing second molding by pressing the first-molded composite substrate to a second depth using a second mold including a punch having a second corner curvature radius; and
performing third molding by pressing the second-molded composite substrate to a third depth using a third mold including a punch having a third corner curvature radius,
the first corner curvature radius, the second corner curvature radius, and the third corner curvature radius are different from one another, and
the first depth, the second depth, and the third depth are different from one another.

15. The battery case as claimed in claim 14, wherein the first corner curvature radius is greater than the second corner curvature radius, and
the second corner curvature radius is greater than the third corner curvature radius.

16. The battery case as claimed in claim 14, wherein the first depth is less than the second depth, and
the second depth is less than the third depth.

17. A battery comprising:
an electrode assembly configured to comprise a positive electrode, a negative electrode, and a separator; and
the battery case of claim 1.

18. A method of manufacturing a battery case, the method comprising:
preparing a composite substrate including a metal layer, an adhesive layer, and a polymer layer; and
manufacturing a lower case by molding the composite substrate using punches having different corner curvature radii,
wherein the composite substrate has a laminated structure in which the metal layer exposed to an outside, the adhesive layer in contact with the metal layer, and the polymer layer in contact with the adhesive layer are laminated.

19. The method as claimed in claim 18, wherein the manufacturing of the lower case comprises:
performing first molding by pressing the composite substrate to a first depth using a first mold including a punch having a first corner curvature radius;
performing second molding by pressing the first-molded composite substrate to a second depth using a second mold including a punch having a second corner curvature radius; and
performing third molding by pressing the second-molded composite substrate to a third depth using a third mold including a punch having a third corner curvature radius,
the first corner curvature radius, the second corner curvature radius, and the third corner curvature radius are different from another, and
the first depth, the second depth, and the third depth are different from one another.

20. The method as claimed in claim 19, wherein the first corner curvature radius is greater than the second corner curvature radius,
the second corner curvature radius is greater than the third corner curvature radius,
the first depth is less than the second depth, and
the second depth is less than the third depth.
